(19) United States
(12) Patent Application Publication
(10) Pub. No.: US 2013/0321924 A1
(43) Pub. Date: Dec. 5, 2013

(54) ANTI-REFLECTION MATERIAL

(71) Applicants: Akihiro Kobayashi, Tokyo (JP); Tatsuya Nakano, Tokyo (JP); Takahisa Takada, Tokyo (JP)

(72) Inventors: Akihiro Kobayashi, Tokyo (JP); Tatsuya Nakano, Tokyo (JP); Takahisa Takada, Tokyo (JP)

(21) Appl. No.: 13/997,055

(22) PCT Filed: Dec. 12, 2011
(86) PCT No.: PCT/JP2011/079268

§ 371 Date: Aug. 15, 2013

(30) Foreign Application Priority Data
Dec. 24, 2010 (JP) 2010-288559

(51) Int. Cl. G02B 1/11

(52) U.S. Cl. CPC G02B 1/11
USPC 359/601

(57) ABSTRACT

An anti-reflection material comprising a coating film formed on at least a part of surface of a substrate having translucency and consisting of a binder, silica particles and air reserves, said silica particles being arranged forming two layers one on the other on the substrate surface, a first layer on the substrate side being formed by covering the substrate surface with the silica particles and having said air reserves between said substrate and said silica particles, and the silica particles of a second layer covering part of the silica particles of said first layer and having said air reserves between the silica particles of said first layer and the silica particles of said second layer.

### TECHNICAL FIELD

This invention relates to an anti-reflection material, and more specifically, it relates to an anti-reflection material which has a coating film formable by carrying out application once, which has anti-reflection performances to ensure that the reflectance in each of the low wavelength region (400 nm) and long wavelength region (800 nm) of optical wavelength is 3.5% or less, that the minimum value of the reflectance is 0.8% or less and that the peak position thereof is 460 to 720 nm, and which ensures that a difference from a substrate material in haze value is 1.5% or less.

### TECHNICAL BACKGROUND

Various displays, lenses and show windows have a problem that visibility is decreased due to the reflection of sunlight, lighting, etc., on their interfaces (surfaces) that are in contact with air. As a method of reducing reflection, there is known a method in which several layers of coating films having different refractive indices are stacked such that reflected light on film surface and reflected light in interface between films and a substrate material offset each other by interference. These films are generally formed by a sputtering, vapor deposition, or coating method. For these films, there have been developed a single-layer film and multi-layered films of two layers, three layers to six layers or more.

When a multi-layered structure of two or more layers is to be formed, no systematic procedures have been established for setting the refractive index and thickness of each layer. Generally, therefore, a process of trial and error is repeated on the basis of a vector method that handles reflected lights like vectors and a complicated matrix method so as to satisfy retardation conditions and amplitude conditions of reflected lights as required, and thereafter there is employed a method of consecutively stacking layers satisfying those conditions.

On the other hand, there is a method of forming a film of magnesium fluoride (MgF₂ refractive index n=1.38) or silicon dioxide (SiO₂ refractive index n=1.46) which is the most common one as a single layer. By forming a single-layered film having a thickness of about 0.1 μm on a substrate, the surface reflectance of the substrate can be reduced.

The minimum reflectance of the single-layered film formed on a substrate can be calculated on the basis of the following expression (1).

Rₘᵢₙ=[(n₁²−n₀n₂)/(n₁²+n₀n₂)]² (1)

n₀: refractive index of air, n₁: refractive index of film, n₂: refractive index of substrate, and when it is supposed that the refractive index of air n₀=1 and that the substrate is a PET film (n₂=1.63), n₁²−n₀n₂=n₁²−1.63, and n₁²=1.63 (the refractive index of film: n₁=1.28), so that it can be expected that Rₘᵢₙ=0.

As a material having a small refractive index, air (n=1) is included. As means of decreasing the refractive index of the film, there is proposed a method of forming air layers in the film by imparting silica with a hollow structure or porous structure (for example, see Patent Documents 1 and 2) or forming nano-sized air bubbles in a film (for example, see Patent Document 3).

Further, as a method of introducing air layers into a film, there is recently studied a method of forming a fine concavoconvex structure on a film surface in various ways. According to this method, the refractive index of the entire layer of the surface having the fine concavoconvex structure formed thereon is determined on the basis of a volume ratio of air and a material on which a fine concavoconvex structure is formed, so that the refractive index can be reduced to a great extent, and that the reflectance can be reduced even when the number of stacked layers is small. For example, there is proposed an anti-reflection film in which pyramid-shaped convex portions are continuously formed on the entire film (for example, see Patent Document 4). In an anti-reflection film having pyramid-shaped convex portions (fine concavoconvex structure) formed as described in Patent Document 4, the cross-sectional area when the film is cut in the film surface direction continuously changes, and the refractive index gradually increases from air to a substrate, so that such a film constitutes an effective anti-reflection means. Further, the above anti-reflection film exhibits excellent optical performances irreplaceable by any other method.

### PRIOR ART DOCUMENTS

### Patent Documents

[Patent Document 1] JP 2007-164154A
[Patent Document 2] JP 2009-54352A
[Patent Document 3] JP 11-281802A
[Patent Document 4] JP 63-75702A

### SUMMARY OF THE INVENTION

### Problems to be Solved by the Invention

For producing a stacked material having a refractive index and a film thickness controlled on the basis of the above vector method or complicated matrix method, it is difficult to control the film thickness by a coating method, so that it is required to control the film thickness on the basis of spurring or vapor deposition. It must be therefore carried out in a closed system, so that it is difficult to form a film on a base material having a large area, and that its productivity is also low.

Meanwhile, a film formed by dispersing hollow-structured silica particles in a transparent resin matrix as described in Patent Document 1, and silica particles having air layers and/or porous silica particles as described in Patent Document 2 have high productivity since films can be formed by coating. And yet air layers are uniformly distributed in the films, so that it is thought that films having a constant refractive index can be obtained. The refractive index is determined, and hence the minimum value of reflectance Rₘᵢₙ is determined, and on the basis of a film thickness, a peak wavelength thereof is determined. In general, the minimum value of reflectance is designed such that its peak position is located at or around a wavelength of 550 nm to which human eyes are the most sensitive. There is therefor caused a problem that the reflectance is increased on the low wavelength side (400 nm) and long wavelength side (800 nm) of the optical wavelength, and that a color combination (blue or red-yellow) comes to be highly visible (see Simulation-1 to be described later).

Meanwhile, in a method of forming nano-sized air bubbles in a film as described in Patent Document 3 or a method of forming a fine concavoconvex structure as described in Patent document 4, it is shown that a continuous change in refractive index made by stepwise increasing the percentage of voids from a substrate to a film surface exhibits excellent anti-reflection performances in the entire optical wavelength region, and it is shown that the gradient structure of refractive index in the film is an effective means in optical properties. In Patent Document 3, however, silica particles having a particle diameter of 10 nm or less are made to form aggregates, a plurality of coating compositions having different contents of nano-sized air bubbles using particle-particle gaps as a space are prepared, and these are consecutively applied to form stacked layers whereby an anti-reflection film is formed. The problem is that since the thickness of each layer is sufficiently large as compared with the particle diameter of the silica particles used, the surface of each layer is flat and smooth, and since it is required to prepare a plurality of coating compositions and since they are consecutively applied one on another, the method is poor in productivity. In Patent Document 4, further, a die having a fine pattern is prepared by an advanced technique employed for producing optical parts, and a pattern is transferred to a substrate with the die and further by thermal, pressure and photo-setting techniques using a high precision pressing apparatus to obtain a material imparted with a nano-sized surface form. However, due to the preparation of the die and productivity, it is thought that a very high cost is required and that it is difficult to produce an anti-reflection film with a large area.

The present invention has been made under the circumstances, and it is an object of this invention to provide an anti-reflection material which is a coating film formable by carrying out application once, which has anti-reflection performances to ensure that the reflectance in each of the low wavelength region (400 nm) and long wavelength region (800 nm) of optical wavelength is as low as 3.5% or less, that the minimum value of the reflectance is 0.8% or less and that the peak position thereof is 460 to 720 nm, and which ensures that a difference from a substrate material in haze value is 1.5% or less.

### Means to Solve the Problems

For achieving the above object, the present inventors have made diligent studies, and as a result, they have aimed at constituting a film structure composed of silica particles, a binder and air reserves. For forming the above film structure, the above silica particles have been arranged to form two layers one on the other on a base material surface, or silica particles to form a first layer are covered on the base material surface, and at the same time, silica particles to form a second layer have been arranged so as to cover some of the above first-layer-forming silica particles preferably in an existing amount ratio of 10-90% to the number of the silica particles of the first layer. Further, the ratio of the binder/silica particles has been adjusted preferably to a mass ratio in the range of 1/99 to 20/80 thereby to form air reserves between the silica particles and the base material and between the silica particles of the first layer and the silica particles of the second layer. Further, when a distance from the base material to the upper end of silica particles of the first layer is taken as H1 and when a distance from the base material to the upper end of silica particles of the second layer is taken as H2, H2/H1 is adjusted preferably to 1.5 or more but 2.1 or less.

By the above structure, an anti-reflection film has a two-step refractivity-gradient structure in which the refractive index repeats an increase→a decrease and, further, an increase→a decrease in a gradient manner, and the refractive index for an entire film gradually decreases, and it has been found that an anti-reflection film suitable for the above object can be obtained. This invention has been completed on the basis of the above finding.

That is, this invention provides:

(1) an anti-reflection material comprising a coating film formed on at least a part of surface of a substrate having translucency and consisting of a binder, silica particles and air reserves, said silica particles being arranged forming two layers one on the other on the substrate surface, a first layer on the substrate side being formed by covering the substrate surface with the silica particles and having said air reserves between said substrate and said silica particles, and the silica particles of a second layer covering part of the silica particles of said first layer and having said air reserves between the silica particles of said first layer and the silica particles of said second layer,

(2) the anti-reflection material as recited in the above (1), wherein the coating film has a binder/silica particles mass ratio of 1/99 to 20/80, and the silica particles of the second layer are arranged in an amount ratio of 10-90% based on the silica particles of the first layer in number,

(3) the anti-reflection material as recited in the above (1) or (2), wherein a distance H1 from the substrate to an upper end of the particles of the first layer and a distance H2 from said substrate to an upper end of the particles of the second layer satisfy the following expression (2),

1.5≦H2/H1≦2.1 (2).

(4) the anti-reflection material as recited in any one of the above (1) to (3), wherein the silica particles have an average particle diameter of 50 to 180 nm, and have a particle size distribution having a coefficient of variation CV value of 35% or less,

(5) the anti-reflection material as recited in any one of the above (1) to (4), wherein the binder is a compound having a polymerizable functional group,

(6) the anti-reflection material as recited in any one of the above (1) to (5), wherein the binder is a compound having at least one polymerizable functional group selected from the group consisting of an acryloyl group, a methacryloyl group and a vinyl group,

(7) the anti-reflection material as recited in any one of the above (1) to (4), wherein the binder is a condensate which is obtained by subjecting an alkoxide compound of the following general formula (3),

(R₁)ₙM(OR₂)ₘ₋ₙ (3)

wherein R₁ is a non-hydrolyzable group, R₂ is an alkyl group having 1 to 6 carbon atoms, M is a metal atom selected among silicon, titanium, zirconium and aluminum, m is a valence of the metal atom M and 3 or 4, and n is an integer of 0 to 2 when m is 4 or an integer of 0-1 when m is 3,

to hydrolysis and condensation reactions, and which has an M-O recurring unit as a main structure,

(8) the anti-reflection material as recited in any one of the above (1) to (7), wherein, in a reflection waveform obtained when the reverse surface of the substrate is blackened, the reflectance at each of 400 nm and 800 nm is 3.5% or less, a minimum value of the reflectance is 0.8% or less, and a peak position thereof is in a region of 460 to 720 nm, and

(9) the anti-reflection material as recited in any one of the above (1) to (8), which has a haze value satisfying the following expression (4),

|Haze value of anti-reflection material−haze value of substrate having translucency|≦1.5 (4).

### Effect of the Invention

According to this invention, there can be provided an anti-reflection material which is a coating film formable by carrying out application once, which has anti-reflection performances to ensure that the reflectance in each of the low wavelength region (400 nm) and long wavelength region (800 nm) of optical wavelength is 3.5% or less, that the minimum value of the reflectance is 0.8% or less and that the peak position thereof is 460 to 720 nm, and which ensures that a difference from a substrate material in haze value is 1.5% or less. The use field of the thus-obtained anti-reflection material includes displays of organic EL, liquid crystal and plasma display panel display units, display screens of display units, glass windows of buildings and automobiles, and surface layers of traffic signs. Further, it also includes an anti-reflection layer that constitutes a relief hologram for forgery prevention. The relief hologram is composed of a reflection layer and an anti-reflection layer and is provided to a card, paper currency and gift certificate. Further, it also includes various optical products. The optical products include an organic EL device as a light source, an LED device and a front light. It further includes uses for improving electric power generation efficiency, i.e., various solar cell panels. Further, the optical products include a polarizing plate, a diffraction grating, a wavelength filter, a light guide plate, a light diffusion film, a subwavelength optical element, a color filter, a condenser sheet, and a cover for a lighting apparatus (cover for organic EL lighting and cover for LED lighting).

### BRIEF DESCRIPTION OF DRAWINGS

FIG. 1 is a schematic cross-sectional view showing one example of the anti-reflection material of this invention.

FIG. 2 is a reflection spectrum in Simulation 1.

FIG. 3 is a reflection spectrum showing a demonstration result in Simulation 2.

FIG. 4 is a scanning electron microscope image of a coating film showing a demonstration result in Simulation 2.

FIG. 5 is an illustration showing the height of each of silica particles of the first layer and silica particles of the second layer in Simulation 3.

FIG. 6 is a graph of refractive indices in Simulation 3.

FIG. 7 is a reflection spectrum in Simulation 3.

FIG. 8 is a scanning electron microscope image showing the stacked state of the first layer in Referential Example 1.

FIG. 9 is a scanning electron microscope image showing the stacked state of the second layer in Referential Example 2.

### PREFERRED EMBODIMENTS OF THE INVENTION

The anti-reflection material of this invention will be explained in detail hereinafter.

### [Structure of Anti-Reflection Material]

The anti-reflection material comprises a coating film formed on at least a part of surface of a substrate having translucency and consisting of a binder, silica particles and air reserves, said silica particles being arranged forming two layers one on the other on the substrate surface, a first layer on the substrate side being formed by covering the substrate surface with the silica particles and having said air reserves between said substrate and said silica particles, and the silica particles of a second layer covering part of the silica particles of said first layer and having said air reserves between the silica particles of said first layer and the silica particles of said second layer.

### (Substrate Having Translucency)

In the anti-reflection material of this invention, the substrate having translucency for use as a support (to be sometimes referred to as a “translucent substrate” hereinafter) can be selected from optical plastics having a total light transmittance, measured according to JIS K 7136, of 30% or more, glass and ceramics. The above plastics include, for example, plastic films, sheets or injection-molded or compression-molded products of polyesters such as polyethylene terephthalate, polybutylene terephthalate and polyethylene naphthalate, polyethylene, polypropylelen, cellophane, diacetyl cellulose, triacetyl cellulose, acetyl cellulose butyrate, polyvinyl chloride, polyvinylidene chloride, polyvinyl alcohol, an ethylene-vinyl acetate copolymer, polystyrene, polycarbonate, polymethylpentene, polysulfone, polyether ether ketone, polyether sulfone, polyetherimide, polyimide, a fluorine resin, polyamide, an acrylic resin, a norbornene-based resin and a cycloolefin resin. Further, the glass includes float plate glass determined under JIS R 3202, polished plate glass, ground plate glass and quartz glass. The ceramics include oxides such as alumina, PLZT (lanthanum lead titanate zirconate), yttria thoria and spinel, and others such as nitride-, carbide- and sulfide-ceramics.

The thickness of the above substrate is not specially limited, and is selected as required depending upon situations. For improving the adhesion of the substrate to a layer to be formed thereon, further, one surface or both surfaces of the substrate may be surface-treated by an oxidizing method or surface-roughening method. Examples of the above oxidizing method include corona-discharge treatment, plasma treatment, chromic acid treatment (wet), flame treatment, hot air treatment and ozone-ultraviolet light irradiation treatment. Examples of the surface-roughening method include a sand blasting method and a solvent treatment method. The surface treatment method is selected as required depending upon the kind of plastics, glass or ceramics to be used as a substrate.

The surface of the above substrate is coated with a coating solution for the above anti-reflection material of this invention by a conventionally know method such as a dip coating method, a spin coating method, a spray coating method, a bar coating method, a knife coating method, a roll coating method, a blade coating method, a die coating method or a gravure coating method, followed by natural drying or drying under heat or exposure to light as required, whereby the anti-reflection material of this invention is formed on the substrate.

### (Binder)

As a binder for constituting the coating film in the anti-reflection material of this invention, there can be used a polymer which is obtained by subjecting a compound having a polymerizable functional group or an alkoxide compound of the following formula,

(R₁)ₙM(OR₂)^{m-n} (3)

wherein R₁ is a non-hydrolyzable group, R₂ is an alkyl group having 1 to 6 carbon atoms, M is a metal atom selected among silicon, titanium, zirconium and aluminum, m is a valence of the metal atom M and 3 or 4, and n is an integer of 0 to 2 when m is 4 or an integer of 0-1 when m is 3,

to hydrolysis and condensation reactions, and which has an M-O recurring unit as a main structure.

The compound having a polymerizable functional group includes an ultraviolet-curable resin and a heat-curable resin. The ultraviolet-curable resin includes an epoxy acrylate-, epoxidized oil acrylate-, urethane acrylate-, polyester urethane acrylate-, polyether urethane acrylate-, unsaturated polyester-, polyester acrylate-, polyether acrylate-, vinyl/acrylate-, polyene/thiol-, silicon acrylate-, polybutadiene acrylate-, polystyrene ethyl methacrylate- and polycarbonate diacrylate-resins. These may be fluorides, and it is sufficient to have a functional group having an unsaturated double bond such as an acryloyl group (CH₂═COCO—) or methacryloyl group (CH₂═C(CH₃)CO—), an allyl group (CH₂═CHCH₂—) or a vinyl group (CH₂═CH—). A plurality of these may be used in combination. Further, when these resins and monomers are used, a photopolymerization initiator may be used depending upon the resins and monomers.

The heat curable resin includes thermosetting resins such as an epoxy resin, a phenolic resin, an alkyd resin, a urea resin, a melamine resin, an unsaturated polyester resin, an aromatic polyamide resin, a polyamide-imide resin, a vinyl ester resin, a polyester-imide resin, a polyimide resin and a polybenzothiazole resin. These resins and monomers may be used singly or in combination of the two or more of these. Further, there may be also used a resin and monomer that is curable by different reaction schemes in the same molecule. When these resins and monomers are used, there may be used a catalytic hardener depending upon resins and monomers.

Of these compounds having polymerizable functional groups, in particular, an ultraviolet curable resin having one or two or more acryloyl groups or methacryloyl groups per molecule or a vinyl group (CH₂═CH—) is preferred from the viewpoint of a curing speed, stability and availability. Examples of known ultraviolet curable resin having one or two or more acryloyl groups or methacryloyl groups per molecule or a vinyl group (CH₂═CH—) include allyl acrylate, allyl methacrylate, benzyl acrylate, benzyl methacrylate, butoxyethyl acrylate, butoxy methacrylate, butoxyethyl methacrylate, butanediol monoacrylate, butoxytriethylene glycol acrylate, t-butylaminoethyl methacrylate, caprolactone acrylate, 3-chloro-2-hydroxypropyl methacrylate, 2-cyanoethyl acrylate, cyclohexyl acrylate, cyclohexyl methacrylate, dicyclopentanyl methacrylate, alicyclic modified neopentyl glycol acrylate, 2,3-dibromopropyl acrylate, 2,3-dibromopropyl methacrylate, dicyclopentenyl acrylate, dicyclopentenyloxyethyl acryl, dicyclopentenyloxyethyl methacrylate, N,N-diethylaminoethyl acrylate, N,N-diethylaminoethyl methacrylate, N,N-dimethylaminoethyl acrylate, N,N-dimethylaminoethyl methacrylate, 2-ethoxyethyl acrylate, 2-ethoxyethyl methacrylate, 2(2-ethoxyethoxy)ethyl acrylate, 2-ethylhexyl acrylate, 2-ethylhexyl methacrylate, glycerol methacrylate, glycidyl acrylate, glycidyl methacrylate, heptadecafluorodecyl acrylate, heptadecafluorodecyl methacrylate, 2-hydroxyethyl acrylate, 2-hydroxyethyl methacrylate, caprolactone-modified 2-hydroxyethyl acrylate, caprolactone-modified 2-hydroxyethyl methacrylate, 2-hydroxy-3-methacryloxypropyltrimethylammonium chloride, 2-hydroxypropyl acrylate, 2-hydroxypropyl methacrylate, isobornyl acrylate, isobornyl methacrylate, isodecyl acrylate, isodecyl methacrylate, isooctyl acrylate, lauryl acrylate, lauryl methacrylate, γ-methacryloxypropyltrimethoxysilane, 2-methoxyethyl acrylate, methoxydiethylene glycol methacrylate, methoxytriethylene glycol acrylate, methoxytriethylene glycol methacrylate, methoxytetraethylene glycol methacrylate, methoxypolyethylene glycol methacrylate, methoxydipropylene glycol acrylate, methoxylated cyclodecatriene acrylate, morpholine acrylate, nonylphenyl polyethylene glycol acrylate, nonylphenoxypolypropylene glycol acrylate, octafluoropentyl acrylate, octafluoropentyl methacrylate, octyl acrylate, phenoxyhydroxypropyl acrylate, phenoxyethyl acrylate, phenoxyethyl methacrylate, phenoxydiethylene glycol acrylate, phenoxytetraethylene glycol acrylate, phenoxyhexaethylene glycol acrylate, EO-modified phenoxylated acrylate phosphate (EO stands for ethylene oxide, and will be used in this sense hereinafter), EO-modified phenoxylated methacrylate phosphate, phenyl methacrylate, EO-modified acrylate phosphate, EO-modified methacrylate phosphate, EO-modified butoxylated acrylate phosphate, EO-modified butoxylated methacrylate phosphate, EO-modified octoxylated acrylate phosphate, EO-modified octoxylated methacrylate phosphate, EO-modified acrylate phthalate, EO-modified methacrylate phthalate, polyethylene glycol methacrylate, polypropylene glycol methacrylate, polyethylene glycol/polypropylene glycol methacrylate, polyethylene glycol/polybutylene glycol methacrylate, stearyl acrylate, stearyl methacrylate, EO-modified acrylate succinate, EO-modified methacrylate succinate, sodium sulfonate ethoxy methacrylate, tetrafluoropropyl acrylate, tetrafluoropropyl methacrylate, tetrahydrofurfuryl acrylate, tetrahydrofurfuryl methacrylate, caprolactone-modified tetrahydrofurfuryl acrylate, trifluoroethylene acrylate, vinyl acetate, N-vinyl caprolactam, N-vinyl pyrrolidone, styrene, allylated cyclohexyl diacrylate, allylated isocyanurate, bis(acryloxyneopentyl glycol) adipate, EO-modified bisphenol A diacrylate, EO-modified bisphenol S diacrylate, bisphenol A dimethacrylate, EO-modified bisphenol A dimethacrylate, EO-modified bisphenol F diacrylate, 1,4-butanediol diacrylate, 1,4-butanediol dimethacrylate, 1,3-butylene glycol dimethacrylate, dicyclopentanyl diacrylate, diethylene glycol diacrylate, diethylene glycol diamethacrylate, dipentacrythritol hexaacrylate, dipentacrythritol monohydroxypentaacrylate, alkyl-modified dipentacrythritol pentaacrylate, alkyl-modified dipentacrythritol tetraacrylate, acryl-modified dipentaerythritol triacrylate, caprolactone-modified dipentaerythritol hexaacrylate, ditrimethylolpropane tetraacrylate, ECH-modified ethylene glycol diacrylate (ECH stands for ethyl cyclohexane, and will be used in this sense hereinafter), ethylene glycol dimethacrylate, ECH-modified ethylene glycol dimethacrylate, glycerol acrylate/methacrylate, glycerol dimethacrylate, ECH-modified glycerol triacrylate, 1,6-hexanediol diacrylate, ECH-modified 1,6-hexanediol diacrylate, 1,6-hexanediol dimethacrylate, long-chain aliphatic diacrylate, long-chain aliphatic dimethacrylate, methoxylated cyclohexyl diacrylate, neopentyl glycol diacrylate, neopentyl glycol dimethacrylate, hydroxypivalic acid neopentyl glycol diacrylate, caprolactone-modified hydroxypivalaic acid neopentyl glycol diacrylate, pentaerythritol triacrylate, pentaerythritol tetraacrylate, pentaerythritol tetramethacrylate, stearic acid-modified pentaerythritol diacrylate, EO-modified phosphoric acid triacrylate, EO-modified phosphoric acid diacrylate, EO-modified phosphoric acid dimethacrylate, ECH-modified phthalic acid diacrylate, polyethylene glycol diacrylate, polyethylene glycol dimethacrylate, polypropylene glycol diacrylate, polypropylene glycol dimethacrylate, EHC-modified propylene glycol diacrylate, tetraethylene glycol diacrylate, tetraethylene glycol dimethacrylate, tetrabromobisphenol A diacrylate, triethylene glycol diacrylate, triethylene glycol dimethacrylate, triethylene glycol divinyl ether, triglycerol diacrylate, neopentyl glycol-modified trimethylolpropane diacrylate, trimethylol propane triacrylate, EO-modified trimethylolpropane triacrylate, PO-modified trimethylolpropane triacrylate (PO stands for polypropylene oxide), trimethylolpropane trimethacrylate, EHC-modified trimethylolpropane triacrylate, tripropylene glycol diacrylate, tris(acryloxyethyl)isocyanurate, caprolactone-modified tris(acryloxyethyl)isocyanurate, and tris(methacryloxyethyl)isocyanurate. These may be used singly or in combination of the two or more of them as required.

The photopolymerization initiator (sensitizer) includes acetophenone-initiators such as 4-phenoxydichloroacetophenone, 4-t-butyl-dichloroacetophenone, 4-t-butyl-trichloroacetophenone, diethoxyacetophenone, 2-hydroxy-2-methyl-1-phenylpropan-1-one, 1-(4-isopropylphenyl)-2hydroxy-2-methylpropan-1-one, 1-(4-dodecylphenyl)-2-hydroxy-2-methylpropan-1-one, 4-(2-hydroxyethoxy-2-propyl)ketone, 1-hydroxycyclohexyl phenyl ketone, and 2-methyl-1-[4-(methylthio)phenyl]-2-morpholinopropan-1-one; benzoin-initiators such as benzoin, benzoin methyl ether, benzoin ethyl ether, benzoin isopropyl ether, benzoin isobutyl ether, and benzyl methyl ketal; benzophenone-initiators such as benzopnone, benzoin benzoic acid, methyl benzoylbenzoate, 4-phenylbenzophenone, hydroxybenzophenone, acrylated benzophenone, 4-benzoyl-4′-methyldiphenyl sulfide, 3,3′-dimethyl-4-methoxybenzophenone, and 3,3′,4,4′-tetra(t-butylperoxycarbonyl)benzophenone; thioxanthone-initiators such as thioxanthone, 2-chlorothioxanthone, 2-methylthioxanthone, 2,4-dimethylthioxanthone, isopropylxanthone, 2,4-dichlorothioxanthone, 2,4-diethylthioxanthone, and 2,4-diisopropylthioxanthone; and other known photopolymerization initiators such as 2,4,6-trimethylbenzoin diphenylphosphine oxide, methyl phenyl glyoxylate, benzyl, 9,10-phenanthlenequinone, camphorquinone, dibenzosuberone, 2-ethylanthraquinone and 4,4″-diethyl isophthalate elon. In addition to these, any compound that causes a polymerization reaction by ultraviolet light may be also used.

In a polymer obtained by subjecting the compound of the above general formula (3) to a hydrolysis-condensation reaction, the main structure is composed of the same recurring unit of M-O as that of silica particles to be described later, and due to good affinity of these and high binding strength, the above polymer can be preferably used for binding the silica particles together and binding the silica particles and a substrate.

In the compound of the above general formula (3), R₁ represents a non-hydrolyzable group, and for example, it represents an alkyl group having 1 to 20 carbon atoms; a (meth)acryloyloxy group-, epoxy group- or mercapto group-possessing alkyl group having 1 to 20 carbon atoms; an alkenyl group having 2 to 20 carbon atoms; an aryl group having 6 to 20 carbon atoms; and or an aralkyl group having 7 to 20 carbon atoms.

The above alkyl group having 1 to 20 carbon atoms is preferably an alkyl group having 1 to 10 carbon atoms, and the alkyl group may be any one of linear, branched and cyclic ones. Examples of the alkyl group include methyl, ethyl, n-propyl, isopropyl, n-butyl, isobutyl, sec-butyl, tert-butyl, pentyl, hexyl, octyl, cyclopentyl and cyclohexyl. The alkyl group having a (meth)acryloyloxy group, an epoxy group or a mercapto group as a substituent and having 1 to 20 carbon atoms is preferably an alkyl group having the above substituent and having 1 to 10 carbon atoms, and the alkyl group may be any one of linear, branched and cyclic ones. Examples of the above alkyl group having the substituent include γ-acryloyloxypropyl, γ-methacryloyloxypropyl, γ-glycidoxypropyl, γ-mercaptopropyl and 3,4-epoxycyclohexyl. The alkenyl group having 2 to 20 carbon atoms is preferably an alkenyl group having 2 to 10 carbon atoms, and the alkenyl group may be any one of linear, branched and cyclic ones. Examples of the above alkenyl group include vinyl, allyl, butenyl, hexenyl and octenyl. The aryl group having 6 to 20 carbon atoms is preferably an aryl group having 6 to 10 carbon atoms, and examples thereof include phenyl, tolyl, xylyl and naphthyl. The aralkyl group having 7 to 20 carbon atoms is preferably an aralkyl group having 7 to 10 carbon atoms, and examples thereof include benzyl, phenethyl, phenylpropyl and naphthylmethyl.

In the compound of the above general formula (3), R₂ is an alkyl group having 1 to 6 carbon atoms, and it may be any one of linear, branched and cyclic ones. Examples thereof include methyl, ethyl, n-propyl, isopropyl, n-butyl, isobutyl, sec-butyl, tert-butyl, pentyl, hexyl, cyclopentyl and cyclohexyl.

In the compound of the above general formula (3), M represents a metal atom selected among silicon, titanium, zirconium and aluminum, and m is a valence number of the metal atom M. It is 3 when the metal atom is aluminum, and it is 4 when the metal atom is silicon, titanium or zirconium. When m is 4, n is an integer of 0 to 2, and when m is 3, n is an integer of 0 or 1.

When a plurality of R₁s are there, each of R₁s may be the same as, or different from, the other or every other one. Further, when a plurality of OR₂s are there, each of OR₂s may be the same as, or different from, the other or every other one.

Examples of the alkoxide compound having the above general formula (3) in which M is a tetravalent silicon, m is 4 and n is an integer of 0 to 2 include tetramethoxysilane, tetraethoxysilane, tetra-n-propoxysilane, tetraisopropoxysilane, tetra-n-butoxysilane, tetraisobutoxysilane, tetra-sec-butoxysilane, tetra-tert-butoxysilane, methyltrimethoxysilane, methyltriethoxysilane, methyltripropoxysilane, methyltriisopropoxysilane, ethyltrimethoxysilane, ethyltriethoxysilane, propyltriethoxysilane, butyltrimethoxysilane, phenyltrimethoxysilane, phenyltriethoxysilane, vinyltrimethoxyslane, vinyltriethoxysilane, γ-glycidoxypropyltrimethoxysilane, γ-mercaptopropyltrimethoxysilane, γ-acryloyloxypropyltrimethoxysilane, γ-methacryloyloxypropyltrimethoxysilane, dimethyldimethoxysilane and methylphenyldimethoxysilane.

Examples of the alkoxide compound having the above general formula (3) in which M is tetravalent titanium or zirconium, m is 4 and n is an integer of 0 to 2 include compounds obtained by replacing the silane of the above-described silane compounds with titanium or zirconium.

Examples of the alkoxide compound having the above general formula (3) in which M is trivalent aluminum, m is 3 and n is an integer of 0 or 1 include trimethoxyaluminum, triethoxyaluminum, tri-n-propoxyaluminum, triisopropoxyaluminum, tri-n-butoxyaluminum, triisobutoxyaluminum, tri-sec-butoxyaluminum, tri-tert-butoxyaluminum, methyldimethoxyaluminum, methyldiethoxyaluminum, methyldipropoxyaluminum, ethyldimethoxyaluminum, ethyldiethoxyaluminum, and propyldiethoxyaluminum.

These alkoxide compounds may be used singly or in combination of the two or more of them.

In this invention, further, there may be used together with the above various alkoxide compounds, oligomers such as alkoxysilane oligomers obtained by subjecting the above various alkoxide compounds to hydrolysis and condensation.

The hydrolysis-condensation reaction of the alkoxide compound of the above general formula (3) is carried out by hydrolyzing the above alkoxide compound, for example, in a proper polar solvent such as an alcohol-, cellosolve-, ketone-, or ether-solvent under acidic conditions using an acid such as hydrochloric acid, sulfuric acid or nitric acid or a cation exchange resin as a solid acid generally at a temperature of 0 to 60° C., preferably 20 to 40° C.; optionally removing the solid acid when such is used; and further distilling off or adding a solvent as required. By the above reaction, there can be obtained a liquid (binder liquid) containing a predetermined concentration of a polymer having a recurring unit of M-O (M is as defined before) as a main structure.

Further, the above binder may contain nano-sized particles of tin oxide (antistatic), ITO (antistatic) or ATO (antistatic) for the purpose of imparting other functions, and further, may contain nano-sized particles of magnesium fluoride, alumina, titanium oxide or zirconium oxide for the purpose of regulating a refractive index. An organic material may be also used if the silica particles to be described later can be fixed.

### (Silica Particles)

In the anti-reflection material of this invention, silica particles are used as a component for constituting the coating film. Since gaps among silica particles are used as air reserves, the silica particles are preferably mono-dispersed and spherical, and the particle diameter thereof has an influence on the reflection waveform peak wavelength and transparency of the film. The average particle diameter is preferably 50 to 180 nm, more preferably 60 to 150 nm, still more preferably 80 to 120 nm.

In the above silica particles, the coefficient of variation CV value of particle size distribution represented by the following expression is preferably 35% or less, more preferably 30% or less, still more preferably 20% or less, from the view point of decreasing the variability of thickness of coating film formed by stacking the silica particles.

CV value (%)=[standard deviation/average particle diameter]×100

The average particle diameter and the coefficient of variation CV value of particle size distribution of the above silica particles are values measured according to the following methods.

### <Method for Measuring Average Particle Diameter of Silica Particles>

Silica particles were diluted with water to prepare a solution having silica particle concentration of 1 mass %, and then, a drop of the solution of the silica particles was fallen on an electron microscope sample bed and dried to prepare a sample. The sample was observed through a scanning electron microscope at a magnification of 50,000, and an average particle diameter of the silica particles was calculated from an image obtained from an electron microscope image through image processing software.

### <Method for Measuring CV Value of Silica Particles>

Silica particles were diluted with water to prepare a solution having silica particle concentration of 1 mass %, and then, a drop of the solution of the silica particles was fallen on an electron microscope sample bed and dried to prepare a sample. The sample was observed through a scanning electron microscope at a magnification of 50,000, an average particle diameter and standard deviation of the silica particles were calculated from an image obtained from an electron microscope image through image processing software, and then a CV value was calculate on the basis of the above expression.

### (Air Reserves)

The coating film in the anti-reflection film of this invention is required to have air reserves together with the above binder and silica particles for decreasing the refractive index of the film.

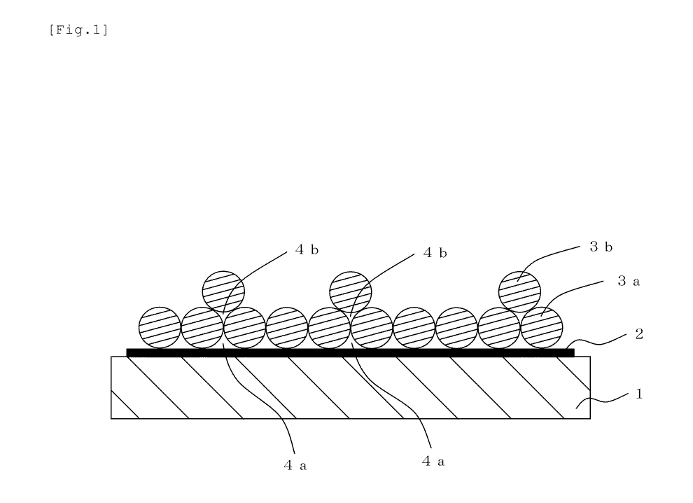

FIG. 1 is a schematic cross-sectional view showing of one example of constitution of the anti-reflection film of this invention, in which silica particles 3a of a first layer are covered on the entire surface of a translucent substrate 1 through a binder layer 2, and silica particles 3b of a second layer are arranged so as to cover some o the silica particles 3a of the first layer.

And, air reserves exist between the binder layer 2 on the translucent substrate 1 and the silica particles 3a of the first layer, and air reserves 4b exist between the silica particles 3a of the first layer and the silica particles 3b of the second layer. The binder is required to exist at least in contact points of the substrate surface and silica particles and in contact points of silica particles and silica particles.

When spheres (silica particles) are packed in a closest packing, the ratio of a space packed with them (packing ratio) is approximately 74%, so that the maximum value of percentage of voids of the coating film in the anti-reflection material of this invention will be approximately 26%. As the voids are filled by the above binder, a smaller amount of the binder is preferred since the voids are increased. However, when the amount of the binder is too small, silica particles come off. Therefore, the mass ratio of the binder and silica particles (binder/particles mass ratio) is preferably 1/99 to 20/80, more preferably 2/98 to 15/85, still more preferably 5/95 to 10/90. When a binder obtained from the alkoxide compound of the general formula (3) in this invention is used, the silica particles and the binder have nearly equal specific gravities, and the binder is filled in voids of (between??) silica particles as a model, so that the percentage of voids is 7.5% when the binder/particles mass ratio is 20/80, 12.9% when it is 15/85, 17.8% when it is 10/90, 22.1% when it is 5/95 and 24.5% when it is 2/98.

When the number of particles of the second layer is too large or too small as compared with the number of particles of the first layer, silica particles constitute a uniform film of two layers or a single layer, and a decrease in reflectance at 400 and 800 nm is no longer sufficient. The ratio of number of particles of the second layer to the number of particles of the first layer is preferably 10 to 90%, more preferably 20 to 80%, still more preferably 40 to 60%.

The ratio of number of particles of the second layer to the number of particles of the first layer is calculated as (X2/X1)×100(%) in which X1 is the number of particles of the first layer in a complete substrate-covering state, calculated from a scanning electron microscope image (magnification of 50,000) using an image processing software and X2 is a value of particles of the second layer measured in the same manner.

In the anti-reflection material of this invention, a state in which the particles of the second layer are stacked is confirmed by the following method. That is, a cross section is observed through a scanning electron microscope (magnification of 50,000-80,000), and then a photograph is placed such that the substrate is on a lower side and that an anti-reflection layer is on an upper side, and a plurality of lines are drawn in parallel with the substrate. Then, a line overlapping with the upper ends of silica particles of the first layer is selected, and a distance H1 from the substrate is measured. Similarly, the silica particles of the second layer are also measured for a distance H2 from the substrate, and H2/H1 is calculated. The value of H2/H1 is preferably 1.5 to 2.1, and when the variability of particle diameters is small with a well-covering state of the first layer on the substrate, it is more preferably 1.7 to 1.9.

With regard to the anti-reflection material of this invention, the following simulations are conducted for more detailed explanation.

### [Simulation 1]

It is considered that a film formed by dispersing silica particles having a hollow structure in a transparent resin matrix as described in the above Patent Document 1 and a coating film containing silica particles having air layers and/or porous silica particles as described in Patent Document 2 have constant refractive indices since the air layers in the films are uniformly distributed.

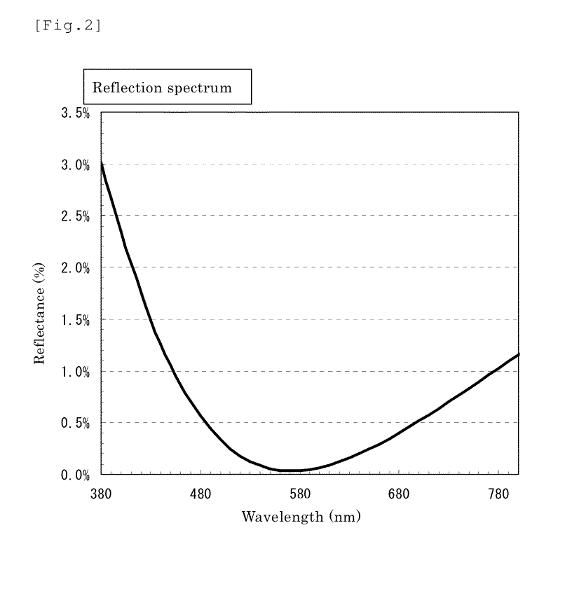

When it is supposed as simulation conditions that a translucent substrate has a refractive index (n) of 1.63, that the film has a thickness (d) of 110 nm, that the film has a refractive index (n) of 1.30 and that the translucent substrate has no reflection on the reverse surface thereof, the relationship (reflection spectrum) of wavelength and reflectance will be as shown in FIG. 2. That is, the reflectance on the low wavelength side (400 nm) and long wavelength side (800 nm) of optical wavelength increases, and a color combination (blue or red-yellow) comes to be conspicuous.

### [Simulation 2]

Concerning a coating composition prepared from a silicon alkoxide binder and silica particles having an average particle diameter of 84 nm (“HIPRESICA”, CV value=18%, supplied by Ube-Nitto Kasei Co., Ltd.) in a mass ratio of 5/95, an application thickness was adjusted such that the number of particles for the second layer based on the number of particles for the first layer was 50%, the reverse surface of a translucent substrate was blackening-treated, and under these conditions, simulation was conducted.

From the above simulation, it was calculated that there was obtained a film having a structure in which particle diameters were about 80 nm and particles for the second layer in an amount of 50% based on the particles for the first layer were stacked and having anti-reflection performances to ensure that the reflectance in a low wavelength region (400 nm) and a long wavelength region (800 nm) of optical wavelength was 3.5% or less, and that the reflectance had a minimum value of 0.8% or less and a peak position at 460-720 nm.

Demonstration results are as shown below.

Rₘᵢₙ−0.10%, peak wavelength=564 nm (reverse surface blackening treatment), haze value 0.9% (a substrate alone)

400 nm reflectance=0.97%, 800 nm reflectance=0.88%, the number of particles for the first layer alone which were covered on the substrate 762, the number of particles of the second layer 427 (427/762)×100 (56%)

Number of particles: A scanning electron microscope image (magnification of 50,000) was measured with an image processing software Mac-View (Mountech Co., Ltd.).

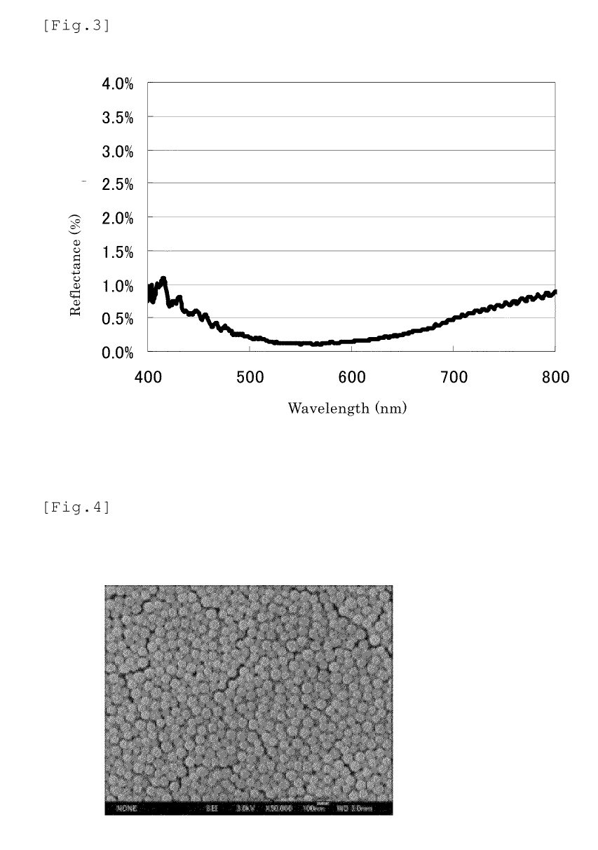

FIG. 3 shows a reflection spectrum as a result of the demonstration (measured with a spectrophotometer “F20” supplied by FILMETRICS Inc.), and FIG. 4 shows the scanning electron microscope (JSM-6700F, JEOL Ltd.) image of coating film of an anti-reflection material obtained.

### [Simulation 3]

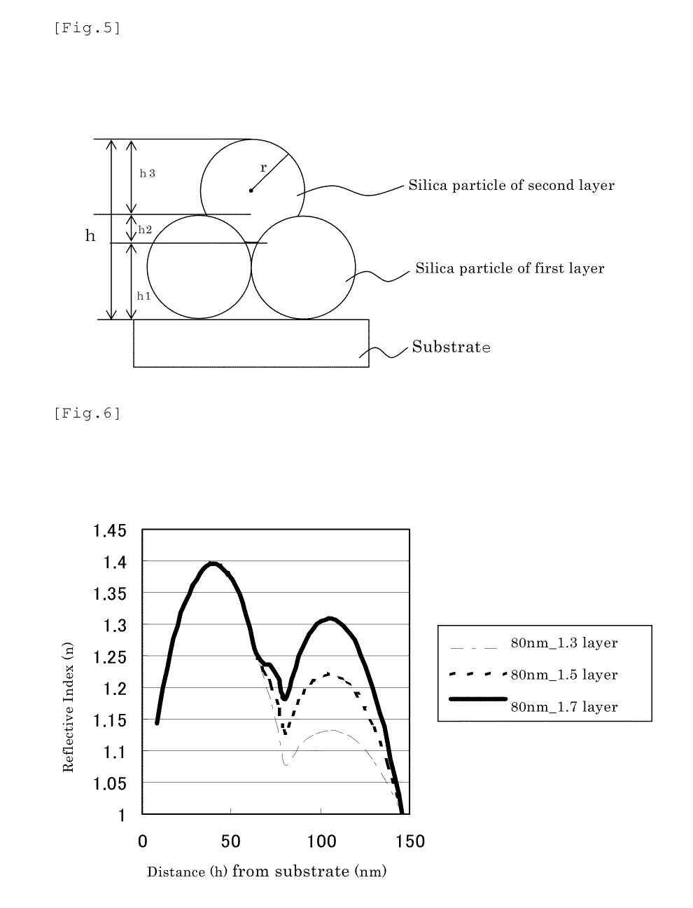

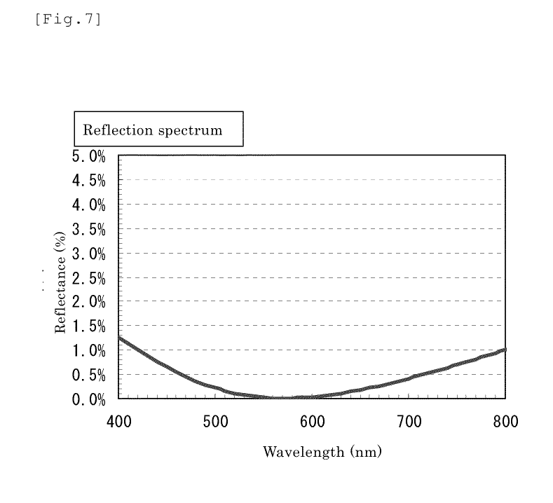

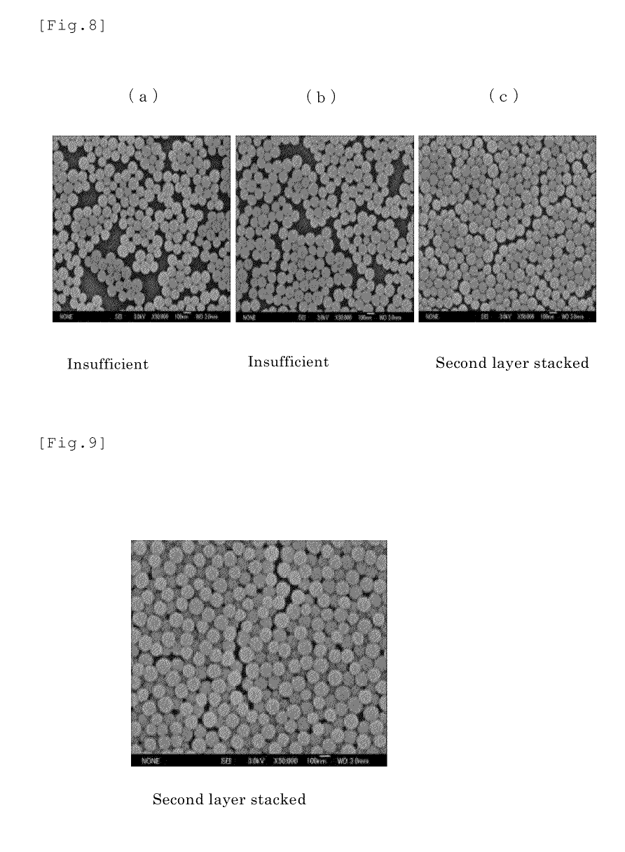

FIG. 5 is an explanation drawing showing each of the heights of silica particles of the first layer and silica particles of the second layer. When the relationships of h=3.64r (r=radius of silica particle), 0≦h1<1.64r, 1.64r≦2<2.00r and 2.00r≦h3<3.64r are satisfied, refractive indices are calculated from a height h from the substrate and cross-sectional forms at heights to give a graph of refractive indices shown in FIG. 6, and when refractive indices are simulated using this structure, the reflection spectrum is as shown in FIG. 7.

### EXAMPLES

This invention will be explained more in detail with reference to Examples, while this invention shall not be limited by these Examples.

Anti-reflection materials obtained in Examples were evaluated by the following methods.

(1) Measurements of Reflectance at 400 Nm and 800 Nm

A black PET film (“Kukkiri-mieru”, supplied by Tomoegawa Paper Co., Ltd.) with an adhesive was laminated on the reverse surface of a sample to prepare a sample.

A sample in the form of 50 mm×50 mm was taken and measured for a reflection waveform with a spectrophotometer (F20, supplied by FILMETRICS Inc.) and measured for reflectance (R) at 400 nm and 800 nm.

Samples were evaluated on the basis of the following 11 ratings according to the following expressions with regard to each reflectance.

10 marks 0≦R<0.2

9 marks 0.2≦R<0.4

8 marks 0.4≦R<0.6

7 marks 0.6≦R<0.8

6 marks 0.8≦R<1.0

5 marks 1.0≦R<1.2

4 marks 1.2≦R<1.4

3 marks 1.4≦R<1.6

2 marks 1.6≦R<1.8

1 mark 1.8≦R<2.0

0 mark 2.0≦R

### (2) Measurements of Reflectance and Waveform at Bottom Peak

A black PET film (“Kukkiri-mieru”, supplied by Tomoegawa Paper Co., Ltd.) with an adhesive was laminated on the reverse surface of a sample to prepare a sample.

A sample in the form of 50 mm×50 mm was taken and measured for a reflection waveform with a spectrophotometer (F20, supplied by FILMETRICS Inc.) and measured for reflectance (Rₘᵢₙ) at a bottom peak and a wavelength (d) thereof.

Samples were evaluated on the basis of the following 11 ratings according to the following expressions with regard to each reflectance Rₘᵢₙ.

10 marks 0≦Rₘᵢₙ<0.1

9 marks 0.1≦Rₘᵢₙ<0.2

8 marks 0.2≦Rₘᵢₙ<0.3

7 marks 0.3≦Rₘᵢₙ<0.4

6 marks 0.4≦Rₘᵢₙ<0.5

5 marks 0.5≦Rₘᵢₙ<0.6

4 marks 0.6≦Rₘᵢₙ<0.7

3 marks 0.7≦Rₘᵢₙ<0.8

2 marks 0.8≦Rₘᵢₙ<0.9

1 mark 0.9≦Rₘᵢₙ<1.0

0 mark 1.0≦Rₘᵢₙ, or a plurality of peaks exist (excluding an interference wave derived from a substrate (e.g., PET film with a hard coat layer)) or it does not exist in the visible light region (400-800 nm).

Samples were evaluated on the basis of the following 11 ratings according to the following expressions with regard to each wavelength d.

10 marks 550≦d<570

9 marks 540≦d<550, 570≦d<580

8 marks 530≦d<540, 580≦d<590

7 marks 520≦d<530, 590≦d<600

6 marks 510≦d<520, 600≦d<610

5 marks 500≦d<510, 610≦d<620

4 marks 490≦d<500, 620≦d<630

3 marks 480≦d<490, 630≦d<640

2 marks 470≦d<480, 640≦d<650

1 mark 460≦d<470, 650≦d<660

0 mark d<460, 660d, or a plurality of peaks exist (excluding an interference wave derived from a substrate (e.g., PET film with a hard coat layer)) or it does not exist in the visible light region (400-800 nm).

(3) ΔHz Measurements

A sample taken in the form of 50 mm×50 mm and a non-treated substrate were prepared. A sample was measured for a haze value with a hazemeter (NDH2000, JISK7361-1, supplied by Nippon Denshoku Industries Co., Ltd.), and ΔHz was calculated on the basis of the following expression.

ΔHz=Haze value of sample−Haze value of substrate|

Samples were evaluated on the basis of the following 11 ratings according to the following expressions with regard to ΔHz.

10 marks 0≦ΔHz<0.2

9 marks 0.2≦ΔHz<0.4

8 marks 0.4≦ΔHz<0.6

7 marks 0.6≦ΔHz<0.8

6 marks 0.8≦ΔHz<1.0

5 marks 1.0≦ΔHz<1.2

4 marks 1.2≦ΔHz<1.4

3 marks 1.4≦ΔHz<1.6

2 marks 1.6≦ΔHz<1.8

1 mark 1.8≦ΔHz<2.0

0 mark 2.0≦ΔHz

(4) General Determination

General determination was made on the basis of an average value of evaluation marks.

⊚: 8.0≦average value

◯: 6.0≦average value<8.0

Δ: 4.0≦average value<6.0

X: average value<4

### Preparation Example 1 Preparation of binder component-1 (B-1)

317.91 Grams of glycidoxypropyltrimethoxysilane and 146.66 g of an oligomer of tetramethoxysilane (trade name “Methylsilicate-51” supplied by COLCOAT CO., Ltd.) were dissolved in 242.70 g of methanol such that the mass ratio of constituent units in a condensate came to be 3:1, and to this was dropwise added a mixture of 32.43 g of a nitric acid solution having a 0.1 mol/L concentration, 225.64 g of water and 34.67 g of methanol. Then, they were allowed to react at 30° C. for 24 hours to give a binder liquid having a solid concentration of 30 mass % [(B)-1 Component].

### Preparation Example 2 Preparation of Binder Component-2 (B-2)

289.05 Grams of mercaptopropyltrimethoxysilane and 222.05 g of titaniumtetraisopropoxide were dissolved in 312.45 g of ethylene glycol mono-t-butyl ether such that the mass ratio of constituent units in a condensate came to be 3:1, and to this was dropwise added a mixture of 101.42 g of concentrated nitric acid, 30.40 g of water and 44.64 g of ethylene glycol mono-t-butyl ether. Then, they were allowed to react at 30° C. for 4 hours to give a binder liquid having a solid concentration of 25 mass % [(B)-2 Component].

### Preparation Example 3 Preparation of Binder Component-3 (B-3)

264.93 Grams of glycidoxypropyltrimethoxysilane and 220.91 g of a solution of 75 mass % zirconium-n-propoxide in n-propanol were dissolved in 367.07 g of ethylene glycol mono-t-butyl ether such that the mass ratio of constituent units in a condensate came to be 3:1, and to this was dropwise added a mixture of 73.24 g of concentrated nitric acid, 21.43 g of water and 52.44 g of ethylene glycol mono-t-butyl ether. Then, they were allowed to react at 30° C. for 4 hours to give a binder liquid having a solid concentration of 25 mass % [(B)-3 Component].

### Preparation Example 4 Preparation of Binder Component-4 (B-4)

289.05 Grams of mercaptopropyltrimethoxysilane and 99.99 g of aluminum-n-butoxide were dissolved in 352.09 g of ethylene glycol mono-t-butyl ether such that the mass ratio of constituent units in a condensate came to be 3:1, and to this was dropwise added a mixture of 80.71 g of concentrated nitric acid, 13.57 g of water and 64.58 g of ethylene glycol mono-t-butyl ether. Then, they were allowed to react at 30° C. for 4 hours to give a binder liquid having a solid concentration of 25 mass % [(B)-4 Component].

### Preparation Example 5 Preparation of Binder Component-5 (B-5)

25.00 Grams of methyl methacrylate and 75.00 g of ethylene glycol mono-t-butyl ether were mixed to prepare a binder liquid having a solid concentration of 25 mass % [(B)-5 Component].

### Preparation Example 6 Preparation of Binder Component-6 (B-6)

25.00 Grams of trimethylolpropane triacrylate and 75.00 g of ethylene glycol mono-t-butyl ether were mixed to prepare a binder liquid having a solid concentration of 25 mass % [(B)-6 Component].

### Preparation Example 7 Preparation of Binder Component-7 (B-7)

25.00 Grams of urethane acrylate (trade name “UV-7600B” supplied by Nippon Synthetic Chemical Industry Co., Ltd.) and 75.00 g of ethylene glycol mono-t-butyl ether were mixed to prepare a binder liquid having a solid concentration of 25 mass % [(B)-7 Component].

### Preparation Example 8 Preparation of Silica Particle Slurry

HIPRESICA (supplied by Ube-Nitto Kasei Co., Ltd.) as a silica material was dispersed in water to prepare silica particle slurries S-1 to S-8 having a solid concentration of 18 mass %. A silica slurry S-9 was prepared by adding water to a commercially available water-dispersed silica particle slurry (SNOWTEX-O, supplied by Nissan Chemical Industries, Ltd., 20 mass %) to adjust a solid concentration of 18 mass %. Table 1 shows all of the slurries.

TABLE 1

| Kind | Average particle diameter (nm) | CV value (%) |
|---|---|---|
| S-1 | 84 | 18 |
| S-2 | 87 | 24 |
| S-3 | 63 | 22 |
| S-4 | 114 | 17 |
| S-5 | 146 | 20 |
| S-6 | 52 | 17 |
| S-7 | 175 | 22 |
| S-8 | 81 | 32 |
| S-9 | 13 | 26 |

An average particle diameter and a CV values were measured according to the following methods.

### <Measurement of Average Particle Diameter>

A silica particle slurry was diluted with water to 1 mass %, and a drop was caused to fall on an electron microscope sample bed and dried to make a sample. It was observed through a scanning electron microscope (JSM-6700F, supplied by JEOL Ltd.) at a magnification of 50,000. An average particle diameter of silica particles was calculated from an image obtained from an electron microscope image using an image processing software (Mac-View, supplied by Mountech Co., Ltd.). Table 1 shows the results.1

### <Measurement of CV Value>

A silica particle slurry was diluted with water to 1 mass %, and a drop was caused to fall on an electron microscope sample bed and dried to make a sample. It was observed through a scanning electron microscope (JSM-6700F, supplied by JEOL Ltd.) at a magnification of 50,000. An average particle diameter and standard deviation were calculated from an image obtained from an electron microscope image using an image processing software (Mac-View, supplied by Mountech Co., Ltd.), and a CV value was calculated on the basis of the following expression. Table 1 shows the results.

CV value (%)=(standard deviation/average particle diameter)×100

### Preparation Example 9 Preparation of Coating Liquid

Coating liquids (P-1 to P-21) were prepared according to the following procedures.

While mixture solutions containing IPA (isopropyl alcohol), MIBK (methyl isobutyl ketone) and ETB (ethylene glycol-t-butyl ether) in amounts shown in Table 2 were stirred, binder components, silica particle slurries and a photopolymerization initiator in amounts shown in Table 2 were added in this order to prepare coating liquids (P-1 to P-21).

TABLE 2

| | | | Total | | | | | | | | | | |
|---|---|---|---|---|---|---|---|---|---|---|---|---|---|
| | | | Liquid | | | | | | | | | | |
| | B/P | Concentration | amount | Binder | | | Silica Particles | | | Initiator [g] | Solvent [g] | | |
| kind | ratio | (mass %) | [g] | kind | (mass %) | [g] | kind | (mass %) | [g] | Darocure1173 | IPA | MIBK | ETB |
| P-1 | 2/98 | 2.0 | 1000 | B-1 | 30 | 1.3 | S-1 | 18 | 108.9 | — | 230.8 | 300.0 | 359.0 |
| P-2 | 5/95 | 2.0 | 1000 | B-1 | 30 | 3.3 | S-1 | 18 | 105.6 | — | 233.6 | 300.0 | 357.5 |
| P-3 | 8/92 | 2.0 | 1000 | B-1 | 30 | 5.3 | S-1 | 18 | 102.2 | — | 236.4 | 300.0 | 356.0 |
| P-4 | 12/88 | 2.0 | 1000 | B-1 | 30 | 8.0 | S-1 | 18 | 97.8 | — | 240.2 | 300.0 | 354.0 |
| P-5 | 5/95 | 2.0 | 1000 | B-1 | 30 | 3.3 | S-2 | 18 | 105.6 | — | 233.6 | 300.0 | 357.5 |
| P-6 | 5/95 | 2.0 | 1000 | B-1 | 30 | 3.3 | S-3 | 18 | 105.6 | — | 233.6 | 300.0 | 357.5 |
| P-7 | 5/95 | 2.0 | 1000 | B-1 | 30 | 3.3 | S-4 | 18 | 105.6 | — | 233.6 | 300.0 | 357.5 |
| P-8 | 5/95 | 2.0 | 1000 | B-1 | 30 | 3.3 | S-5 | 18 | 105.6 | — | 233.6 | 300.0 | 357.5 |
| P-9 | 5/95 | 2.0 | 1000 | B-2 | 25 | 4.0 | S-1 | 18 | 105.6 | — | 233.4 | 300.0 | 357.0 |
| P-10 | 5/95 | 2.0 | 1000 | B-3 | 25 | 4.0 | S-1 | 18 | 105.6 | — | 233.4 | 300.0 | 357.0 |
| P-11 | 5/95 | 2.0 | 1000 | B-4 | 25 | 4.0 | S-1 | 18 | 105.6 | — | 233.4 | 300.0 | 357.0 |
| P-12 | 5/95 | 2.0 | 1000 | B-5 | 25 | 4.0 | S-1 | 18 | 105.6 | 0.2 | 235.2 | 300.0 | 355.0 |
| P-13 | 5/95 | 2.0 | 1000 | B-6 | 25 | 4.0 | S-1 | 18 | 105.6 | 0.2 | 235.2 | 300.0 | 355.0 |
| P-14 | 5/95 | 2.0 | 1000 | B-7 | 25 | 4.0 | S-1 | 18 | 105.6 | 0.2 | 235.2 | 300.0 | 355.0 |
| P-15 | 0/100 | 2.0 | 1000 | B-1 | 30 | 0.0 | S-1 | 18 | 111.1 | — | 228.9 | 300.0 | 360.0 |
| P-16 | 20/80 | 2.0 | 1000 | B-1 | 30 | 13.3 | S-1 | 18 | 88.9 | — | 247.7 | 300.0 | 350.1 |
| P-17 | 25/75 | 2.0 | 1000 | B-1 | 30 | 16.7 | S-1 | 18 | 83.3 | — | 252.4 | 300.0 | 347.6 |
| P-18 | 5/95 | 2.0 | 1000 | B-1 | 30 | 3.3 | S-6 | 18 | 105.6 | — | 233.6 | 300.0 | 357.5 |
| P-19 | 5/95 | 2.0 | 1000 | B-1 | 30 | 3.3 | S-7 | 18 | 105.6 | — | 233.6 | 300.0 | 357.5 |
| P-20 | 5/95 | 2.0 | 1000 | B-1 | 30 | 3.3 | S-8 | 18 | 105.6 | — | 233.6 | 300.0 | 357.5 |
| P-21 | 5/95 | 2.0 | 1000 | B-1 | 30 | 3.3 | S-9 | 18 | 105.6 | — | 233.6 | 300.0 | 357.5 |

(B/P ratio: Binder/particles mass ratio)

### Referential Example 1 Studies of Arrangement of First Layer

As a method of producing an anti-reflection material and a method of confirming a stacked state, arrangements of the first layer were studied. The following Referential Example showed a method of producing an anti-reflection material by a bar-coating method and a method of confirming a stacked state, while studies of a method of producing an anti-reflection material by other coating method and a method of confirming a stacked state were also made in the same manner.

A corona-treated (500 dyne/cm) cycloolefin polymer film of A-4 size (ZEONOR ZF-14-100, supplied by ZEON CORPORATION) was employed, the above coating liquid P-2 was applied to the corona-treated surface thereof by a bar-coating method while bar-No. (liquid film thickness of coating liquid) was changed, and the applied coating liquid was dried in an oven at 120° C. for 2 minutes to make a film. The thus-obtained film was observed for a stacked state through a scanning electron microscope (JSM-6700F, supplied by JEOL Ltd.) at a magnification of 50,000.

FIG. 8 shows a scanning electron microscope photograph of stacked state of the first layer. In FIG. 8, (a) and (b) show that silica particles are in an insufficient state, and (c) shows that silica particles are covered on an entire surface of the substrate.

By the above studies, a coating condition under which the coating liquid P-2 could be covered on an entire surface was determined. However, when no optimum coating condition using a bar No. was not found, it was addressed by adjusting a concentration. Further, the number of particles in the plane was calculated from a scanning electron microscope photograph image of a sample in which particles for the first layer were covered on the substrate by the use of an image processing software (Mac-View, supplied by Mountech Co., Ltd.). Table 3 shows the numbers of particles in a state where particles for the first layer of coating liquids were covered on the entire surfaces of substrates.

TABLE 3

| | Number of particles (pcs) in a state where the |
|---|---|
| | particles for one layer are covered on an entire |
| Coating liquid | surface |
| P-1 | 753 |
| P-2 | 762 |
| P-3 | 756 |
| P-4 | 760 |
| P-5 | 721 |
| P-6 | 1307 |
| P-7 | 436 |
| P-8 | 238 |
| P-9 | 744 |
| P-10 | 774 |
| P-11 | 753 |
| P-12 | 757 |
| P-13 | 752 |
| P-14 | 739 |
| P-15 | — |
| P-16 | 771 |
| P-17 | 762 |
| P-18 | 2064 |
| P-19 | 168 |
| P-20 | 779 |
| P-21 | 33165 |

### Referential Example 2 Studies of Arrangement of Second Layer

On the basis of the coating condition obtained from the above “Studies of arrangement of first layer”, a second layer was coated by adjusting a bar No. or concentration so as to give an intended stacked state.

As a result, it was found that when the first layer could be coated with a bar No. 5 and when it was intended to make a 1.6 layer (the number of particles of the second layer was 60% based on the number of particles of the first layer), it was sufficient to select a bar No. 8.

Further, it was found that when the first layer could be coated with a bar No. 5 and when it was intended to make a 1.3 layer (the number of particles of the second layer was 30% based on the number of particles of the first layer), it was sufficient to select a bar No. 7 and a concentration of 0.93 times (concentration after diluted 1.86 mass % (diluted with IPA)).

The thus-obtained film was observed through a scanning electron microscope (JSM-6700F, supplied by JEOL Ltd.) at a magnification of 50,000. FIG. 9 shows this scanning electron microscope image. Further, the number of particles of the second layer was calculated from the scanning electron microscope image by the use of an image processing software (Mac-View, supplied by Mountech Co., Ltd.).

### <Calculation of Stacked State>

A ratio of the number of particles of the second layer to the number of particles of the first layer was calculated from the numbera of particles of the first layer and second layer obtained by the use of the image processing software (Mac-View, supplied by Mountech Co., Ltd.).

Stacked state=(number of particles of the second layer/number of particles of the first layer)×100

### Referential Example 3 Comparative Stacked Sample (Stacking of 4 Layers or More)

On the basis of the coating condition obtained from the above

“Studies of arrangement of first layer”, a coating was carried out by adjusting a bar No. or concentration so as to give a film of four or more layers.

As a result, it was found that when the first layer could be coated with a bar No. 5 and when it was intended to make a film of four layers, it was sufficient to select a bar No. 20.

### Example 1

A corona-treated (500 dyne/cm) cycloolefin polymer film/100 μm of A-4 size (“COP” hereinafter)(supplied by ZEON CORPORATION) was employed, the above coating liquid P-2 was applied to the corona-treated surface thereof by a bar-coating method such that the number of particles of the second layer based on the number of particles of the first layer came to be 50%, and then, the applied coating liquid was dried in an oven at 120° C. for 2 minutes to make an anti-reflection material. Tables 4 and 5 show the evaluation results of the thus-obtained anti-reflection film.

### Example 2

The same procedures as those in Example 1 were repeated except that the coating liquid was replaced with P-1. Tables 4 and 5 show the evaluation results of the thus-obtained anti-reflection material.

### Example 3

The same procedures as those in Example 1 were repeated except that the coating liquid was replaced with P-3. Tables 4 and 5 show the evaluation results of the thus-obtained anti-reflection material.

### Example 4

The same procedures as those in Example 1 were repeated except that the coating liquid was replaced with P-4. Tables 4 and 5 show the evaluation results of the thus-obtained anti-reflection material.

### Example 5

The same procedures as those in Example 1 were repeated except that the number of particles of the second layer based on the number of particles of the first layer was changed to 25%. Tables 4 and 5 show the evaluation results of the thus-obtained anti-reflection material.

### Example 6

The same procedures as those in Example 1 were repeated except that the number of particles of the second layer based on the number of particles of the first layer was changed to 75%. Tables 4 and 5 show the evaluation results of the thus-obtained anti-reflection material.

### Example 7

The same procedures as those in Example 1 were repeated except that the coating liquid was replaced with P-5. Tables 4 and 5 show the evaluation results of the thus-obtained anti-reflection material.

### Example 8

The same procedures as those in Example 1 were repeated except that the coating liquid was replaced with P-6. Tables 4 and 5 show the evaluation results of the thus-obtained anti-reflection material.

### Example 9

The same procedures as those in Example 1 were repeated except that the coating liquid was replaced with P-7. Tables 4 and 5 show the evaluation results of the thus-obtained anti-reflection material.

### Example 10

The same procedures as those in Example 1 were repeated except that the coating liquid was replaced with P-8. Tables 4 and 5 show the evaluation results of the thus-obtained anti-reflection material.

### Example 11

The same procedures as those in Example 1 were repeated except that the coating liquid was replaced with P-9. Tables 4 and 5 show the evaluation results of the thus-obtained anti-reflection material.

### Example 12

The same procedures as those in Example 1 were repeated except that the coating liquid was replaced with P-10. Tables 4 and 5 show the evaluation results of the thus-obtained anti-reflection material.

### Example 13

The same procedures as those in Example 1 were repeated except that the coating liquid was replaced with P-11. Tables 4 and 5 show the evaluation results of the thus-obtained anti-reflection material.

### Example 14

The same procedures as those in Example 1 were repeated except that the coating liquid was replaced with P-12, that the drying temperature was changed to 80° C. and that irradiation with ultraviolet light (high-pressure mercury lamp, 500 mJ/cm²) was carried out after the drying. Tables 4 and 5 show the evaluation results of the thus-obtained anti-reflection material.

### Example 15

The same procedures as those in Example 14 were repeated except that the coating liquid was replaced with P-13. Tables 4 and 5 show the evaluation results of the thus-obtained anti-reflection material.

### Example 16

The same procedures as those in Example 14 were repeated except that the coating liquid was replaced with P-14. Tables 4 and 5 show the evaluation results of the thus-obtained anti-reflection material.

### Example 17

The same procedures as those in Example 1 were repeated except that the substrate was replaced with a corona-treated (50 dyne/cm) PET film (“PET” hereinafter) (Cosmoshine A4100/100 w, supplied by Toyobo Co., Ltd., coating surface=PET surface). Tables 4 and 5 show the evaluation results of the thus-obtained anti-reflection material.

### Example 18

The same procedures as those in Example 1 were repeated except that the substrate was replaced with the HC surface of a corona-treated (50 dyne/cm) hard coat-layered PET film (“HC-layered PET” hereinafter) [substrate: Lummirror T60/125 w, supplied by Toray Industries, Inc., HC (hard coat) material: ultraviolet curable resin (UV-1700B, supplied by Nippon Synthetic Chemical Industry Co., Ltd.), photopolymerization initiator (Darocure 1173, supplied by Nagase & Co., Ltd.), thickness after cured: 10 μm]. Tables 4 and 5 show the evaluation results of the thus-obtained anti-reflection material.

### Example 19

The same procedures as those in Example 1 were repeated except that the substrate was replaced with a corona-treated (50 dyne/cm) colorless transparent acryl plate (ACRYLITE L, 2 mm thick, supplied by Mitsubishi Rayon Co., Ltd.) and that the coating method was changed to a dip-coating method. Tables 4 and 5 show the evaluation results of the thus-obtained anti-reflection material.

### Example 20

The same procedures as those in Example 19 were repeated except that the substrate was replaced with a degreased (White 7-AL, supplied by U.I. Kasei K.K.) glass plate (S-9213, supplied by Matsunami Glass Ind., Ltd.). Tables 4 and 5 show the evaluation results of the thus-obtained anti-reflection material.

### Comparative Example 1

The same procedures as those in Example 1 were repeated except that the coating liquid was replaced with P-15. With the coating liquid P-15, silica particles were not fixed, and the conditions for covering the entire surface with one layer by the method in Referential Example 1 and the number of particles could not be determined, so that conditions were determined as the coating liquid P-15 was taken the same as the coating liquid P-2. Tables 4 and 5 show the evaluation results of the thus-obtained anti-reflection material.

### Example 21

The same procedures as those in Example 1 were repeated except that the coating liquid was replaced with P-16. Tables 4 and 5 show the evaluation results of the thus-obtained anti-reflection material.

### Example 22

The same procedures as those in Example 1 were repeated except that the number of particles for the second layer was changed to 10% of the number of particles for the first layer. Tables 4 and 5 show the evaluation results of the thus-obtained anti-reflection material.

### Example 23

The same procedures as those in Example 1 were repeated except that the number of particles for the second layer was changed to 90% of the number of particles for the first layer. Tables 4 and 5 show the evaluation results of the thus-obtained anti-reflection material.

### Example 24

The same procedures as those in Example 1 were repeated except that the coating liquid was replaced with P-18. Tables 4 and 5 show the evaluation results of the thus-obtained anti-reflection material.

### Example 25

The same procedures as those in Example 1 were repeated except that the coating liquid was replaced with P-19. Tables 4 and 5 show the evaluation results of the thus-obtained anti-reflection material.

### Example 26

The same procedures as those in Example 1 were repeated except that the coating liquid was replaced with P-20. Tables 4 and 5 show the evaluation results of the thus-obtained anti-reflection material.

### Comparative Example 2

The same procedures as those in Example 1 were repeated except that the coating liquid was replaced with P-17. With the coating liquid P-17, silica particles formed aggregates, and the conditions for covering the entire surface with one layer by the method in Referential Example 1 and the number of particles could not be determined, so that conditions were determined as the coating liquid P-15 was taken the same as the coating liquid P-2. Tables 4 and 5 show the evaluation results of the thus-obtained anti-reflection material.

### Comparative Example 3

Procedures were carried out with the coating liquid of Example 1 such that four layers were stacked as a stacked state. Tables 4 and 5 show the evaluation results of the thus-obtained anti-reflection material.

### Comparative Example 4

The same procedures as those in Comparative Example 3 were repeated except that the coating liquid was replaced with P-21. Tables 4 and 5 show the evaluation results of the thus-obtained anti-reflection material.

### Comparative Example 5

Procedures were carried out with the coating liquid of Example 1 such that one layer was stacked as a stacked state. Tables 4 and 5 show the evaluation results of the thus-obtained anti-reflection material.

### Comparative Example 6

The same procedures as those in Comparative Example 5 were repeated except that the coating liquid was replaced with P-7. Tables 4 and 5 show the evaluation results of the thus-obtained anti-reflection material.

### Comparative Example 7

The same procedures as those in Comparative Example 5 were repeated except that the coating liquid was replaced with P-8. Tables 4 and 5 show the evaluation results of the thus-obtained anti-reflection material.

TABLE 4

| | Coating composition | | | | | | | | | | | | | |
|---|---|---|---|---|---|---|---|---|---|---|---|---|---|---|
| | | Particles | | | | | | | | Reflectance | | Bottom peak | | |
| | | | CV | | B/P ratio | | Stacked state | | | 400 | 800 | | Wave- | |
| | | APD | value | Binder | (mass | | PNR (%) | | | nm | nm | Reflectance | length | [symbol] Hz |
| | kind | (nm) | (%) | kind | ratio) | Substrate | Set | Found | H2/H1 | (%) | (%) | (%) | (nm) | (%) |
| Ex. 1 | P-2 | 84 | 18 | B-1 | 5/95 | COP | 50 | 56 | 1.86 | 0.97 | 0.88 | 0.10 | 564 | 0.20 |
| Ex. 2 | P-1 | 84 | 18 | B-1 | 2/98 | COP | 50 | 52 | 1.82 | 0.93 | 0.87 | 0.06 | 559 | 0.72 |
| Ex. 3 | P-3 | 84 | 18 | B-1 | 8/92 | COP | 50 | 54 | 1.79 | 0.98 | 0.90 | 0.12 | 562 | 0.23 |
| Ex. 4 | P-4 | 84 | 18 | B-1 | 12/88 | COP | 50 | 45 | 1.83 | 1.18 | 1.42 | 0.21 | 577 | 0.18 |
| Ex. 5 | P-2 | 84 | 18 | B-1 | 5/95 | COP | 25 | 22 | 1.81 | 0.96 | 1.46 | 0.28 | 513 | 0.21 |
| Ex. 6 | P-2 | 84 | 18 | B-1 | 5/95 | COP | 75 | 73 | 1.86 | 1.38 | 0.87 | 0.24 | 608 | 0.22 |
| Ex. 7 | P-5 | 87 | 24 | B-1 | 5/95 | COP | 50 | 49 | 1.92 | 0.97 | 0.91 | 0.16 | 573 | 0.55 |
| Ex. 8 | P-6 | 63 | 22 | B-1 | 5/95 | COP | 50 | 53 | 1.96 | 0.94 | 1.40 | 0.12 | 543 | 0.37 |
| Ex. 9 | P-7 | 114 | 17 | B-1 | 5/95 | COP | 50 | 57 | 1.72 | 0.77 | 0.97 | 0.08 | 589 | 0.29 |
| Ex. 10 | P-8 | 146 | 20 | B-1 | 5/95 | COP | 50 | 51 | 1.74 | 1.45 | 0.62 | 0.06 | 621 | 0.74 |
| Ex. 11 | P-9 | 84 | 18 | B-2 | 5/95 | COP | 50 | 55 | 1.83 | 0.95 | 0.98 | 0.12 | 563 | 0.18 |
| Ex. 12 | P-10 | 84 | 18 | B-3 | 5/95 | COP | 50 | 49 | 1.80 | 0.91 | 0.97 | 0.11 | 571 | 0.22 |
| Ex. 13 | P-11 | 84 | 18 | B-4 | 5/95 | COP | 50 | 54 | 1.83 | 1.04 | 0.89 | 0.09 | 582 | 0.14 |
| Ex. 14 | P-12 | 84 | 18 | B-5 | 5/95 | COP | 50 | 47 | 1.82 | 0.91 | 0.94 | 0.14 | 563 | 0.18 |
| Ex. 15 | P-13 | 84 | 18 | B-6 | 5/95 | COP | 50 | 43 | 1.84 | 0.94 | 1.08 | 0.12 | 551 | 0.24 |
| Ex. 16 | P-14 | 84 | 18 | B-7 | 5/95 | COP | 50 | 53 | 1.78 | 1.03 | 0.90 | 0.16 | 574 | 0.20 |
| Ex. 17 | P-2 | 84 | 18 | B-1 | 5/95 | PET | 50 | 54 | 1.82 | 0.97 | 0.90 | 0.14 | 560 | 0.21 |
| Ex. 18 | P-2 | 84 | 18 | B-1 | 5/95 | PET | 50 | 47 | 1.86 | 0.96 | 0.86 | 0.11 | 557 | 0.17 |
| | | | | | | w/HC | | | | | | | | |
| Ex. 19 | P-2 | 84 | 18 | B-1 | 5/95 | Acryl | 50 | 53 | 1.84 | 0.83 | 1.21 | 0.08 | 582 | 0.11 |
| Ex. 20 | P-2 | 84 | 18 | B-1 | 5/95 | Glass | 50 | 56 | 1.79 | 0.91 | 0.97 | 0.11 | 577 | 0.14 |
| CEx. 1 | P-15 | 84 | 18 | B-1 | 1/99 | COP | 50 | off | — | — | — | — | — | — |
| Ex. 21 | P-16 | 84 | 18 | B-1 | 20/80 | COP | 50 | 53 | 2.07 | 1.21 | 1.11 | 0.63 | 571 | 0.66 |
| Ex. 22 | P-2 | 84 | 18 | B-1 | 5/95 | COP | 10 | 14 | 1.80 | 2.63 | 2.20 | 0.23 | 531 | 0.21 |
| Ex. 23 | P-2 | 84 | 18 | B-1 | 5/95 | COP | 90 | 87 | 1.82 | 2.38 | 2.09 | 0.26 | 611 | 0.24 |
| Ex. 24 | P-18 | 52 | 17 | B-1 | 5/95 | COP | 50 | 45 | 1.88 | 0.86 | 3.42 | 0.13 | 475 | 0.23 |
| Ex. 25 | P-19 | 175 | 22 | B-1 | 5/95 | COP | 50 | 52 | 1.72 | 3.15 | 0.54 | 0.06 | 712 | 0.25 |
| Ex. 26 | P-20 | 81 | 32 | B-1 | 5/95 | COP | 50 | 43 | 1.51 | 1.23 | 0.86 | 0.11 | 635 | 1.22 |
| CEx. 2 | P-17 | 84 | 18 | B-1 | 25/75 | COP | 50 | Aggregates | — | — | — | — | — | — |
| CEx. 3 | P-2 | 84 | 18 | B-1 | 5/95 | COP | 4 layers | — | — | 2.10 | 4.32 | plural | plural | 2.43 |
| CEx. 4 | P-21 | 13 | 26 | B-1 | 5/95 | COP | 4 layers | — | — | 1.64 | 4.45 | nil | nil | 0.07 |
| CEx. 5 | P-2 | 84 | 18 | B-1 | 5/95 | COP | 1 layer | — | — | 1.08 | 3.64 | Nil | nil | 0.11 |
| CEx. 6 | P-7 | 114 | 17 | B-1 | 5/95 | COP | 1 layer | — | — | 1.81 | 1.72 | 0.51 | 611 | 0.87 |
| CEx. 7 | P-8 | 116 | 20 | B-1 | 5/95 | COP | 1 layer | — | — | 4.15 | 0.72 | 0.46 | 756 | 1.04 |

Ex.: Example,
CEx.: Comparative Example,
APD: Average particle diameter,
PNR: Particle number ratio,
B/P ratio: Binder/silica particles mass ratio

TABLE 5

| | Evaluation marks | | | | | General | |
|---|---|---|---|---|---|---|---|
| | Reflectance | | Bottom peak | | | evaluation | |
| | 400 nm (marks) | 800 nm (marks) | RT (marks) | WL (marks) | [symbol] Hz (marks) | Average | Evaluation |
| Example 1 | 6 | 6 | 9 | 10 | 9 | 8.0 | ⊚ |
| Example 2 | 6 | 6 | 10 | 10 | 7 | 7.8 | ◯ |
| Example 3 | 6 | 6 | 9 | 10 | 9 | 8.0 | ⊚ |
| Example 4 | 5 | 3 | 8 | 9 | 10 | 7.0 | ◯ |
| Example 5 | 6 | 3 | 8 | 6 | 9 | 6.4 | ◯ |
| Example 6 | 4 | 6 | 8 | 6 | 9 | 6.6 | ◯ |
| Example 7 | 6 | 6 | 9 | 9 | 8 | 7.6 | ◯ |
| Example 8 | 6 | 3 | 9 | 9 | 9 | 7.2 | ◯ |
| Example 9 | 7 | 6 | 10 | 8 | 9 | 8.0 | ⊚ |
| Example 10 | 3 | 7 | 10 | 4 | 7 | 6.2 | ◯ |
| Example 11 | 6 | 6 | 9 | 10 | 10 | 8.2 | ⊚ |
| Example 12 | 6 | 6 | 9 | 9 | 9 | 7.8 | ◯ |
| Example 13 | 5 | 6 | 10 | 8 | 10 | 7.8 | ◯ |
| Example 14 | 6 | 6 | 9 | 10 | 10 | 8.2 | ⊚ |
| Example 15 | 6 | 5 | 9 | 10 | 9 | 7.8 | ◯ |
| Example 16 | 5 | 6 | 9 | 9 | 9 | 7.6 | ◯ |
| Example 17 | 6 | 6 | 9 | 10 | 9 | 8.0 | ⊚ |
| Example 18 | 6 | 6 | 9 | 10 | 10 | 8.2 | ⊚ |
| Example 19 | 6 | 4 | 10 | 8 | 10 | 7.6 | ◯ |
| Example 20 | 6 | 6 | 9 | 9 | 10 | 8.0 | ⊚ |
| CEx. 1 | — | — | — | — | — | — | — |
| Example 21 | 4 | 5 | 4 | 9 | 7 | 5.8 | Δ |
| Example 22 | 0 | 0 | 8 | 8 | 9 | 5.0 | Δ |
| Example 23 | 0 | 0 | 8 | 5 | 9 | 4.4 | Δ |
| Example 24 | 6 | 0 | 9 | 2 | 9 | 5.2 | Δ |
| Example 25 | 0 | 8 | 10 | 1 | 4 | 4.6 | Δ |
| Example 26 | 4 | 6 | 9 | 3 | 4 | 5.2 | Δ |
| CEx. 2 | — | — | — | — | — | — | — |
| CEx. 3 | 0 | 0 | 0 | 0 | 0 | 0.0 | X |
| CEx. 4 | 2 | 0 | 0 | 0 | 10 | 2.4 | X |
| CEx. 5 | 5 | 0 | 0 | 0 | 9 | 2.8 | X |
| CEx. 6 | 1 | 2 | 5 | 5 | 6 | 3.8 | X |
| CEx. 7 | 0 | 7 | 6 | 1 | 5 | 3.8 | X |

CEx. = Comparative Example,
RT = Reflectance,
WL = wavelength

### INDUSTRIAL UTILITY

The anti-reflection material of this invention has a coating film formable by carrying out application once, has anti-reflection performances to ensure that the reflectance in each of the low wavelength region (400 nm) and long wavelength region (800 nm) of optical wavelength is 3.5% or less, that the minimum value of the reflectance is 0.8% or less and that the peak position thereof is 460 to 720 nm, and has an excellent property to ensure that a difference from a substrate material in haze value is 1.5% or less.

1. An anti-reflection material comprising a coating film formed on at least a part of surface of a substrate having translucency and consisting of a binder, silica particles and air reserves, said silica particles being arranged forming two layers one on the other on the substrate surface, a first layer on the substrate side being formed by covering the substrate surface with the silica particles and having said air reserves between said substrate and said silica particles, and the silica particles of a second layer covering part of the silica particles of said first layer and having said air reserves between the silica particles of said first layer and the silica particles of said second layer.

2. The anti-reflection material as recited in claim 1, wherein the coating film has a binder/silica particles mass ratio of 1/99 to 20/80, and the silica particles of the second layer are arranged in an amount ratio of 10-90% based on the silica particles of the first layer in number.

3. The anti-reflection material as recited in claim 1, wherein a distance H1 from the substrate to an upper end of the particles of the first layer and a distance H2 from said substrate to an upper end of the particles of the second layer satisfy the following expression (2),
1.5≦H2/H1≦2.1 (2).

4. The anti-reflection material as recited in claim 1, wherein the silica particles have an average particle diameter of 50 to 180 nm, and have a particle size distribution having a coefficient of variation CV value of 35% or less.

5. The anti-reflection material as recited in claim 1, wherein the binder is a compound having a polymerizable functional group.

6. The anti-reflection material as recited claim 1, wherein the binder is a compound having at least one polymerizable functional group selected from the group consisting of an acryloyl group, a methacryloyl group and a vinyl group.

7. The anti-reflection material as recited in claim 1, wherein the binder is a condensate which is obtained by subjecting an alkoxide compound of the following general formula (3),
(R₁)ₙM(OR₂)ₘ₋ₙ (3)
wherein R₁ is a non-hydrolyzable group, R₂ is an alkyl group having 1 to 6 carbon atoms, M is a metal atom selected among silicon, titanium, zirconium and aluminum, m is a valence of the metal atom M and 3 or 4, and n is an integer of 0 to 2 when m is 4 or an integer of 0-1 when m is 3,
to hydrolysis and condensation reactions, and which has an M-O recurring unit as a main structure.

8. The anti-reflection material as recited in claim 1, wherein, in a reflection waveform obtained when the reverse surface of the substrate is blackened, the reflectance at each of 400 nm and 800 nm is 3.5% or less, a minimum value of the reflectance is 0.8% or less, and a peak position thereof is in a region of 460 to 720 nm.

9. The anti-reflection material as recited in claim 1, which has a haze value satisfying the following expression (4),

|Haze value of anti-reflection material−haze value of substrate having translucency|≦1.5 (4).
